(19) United States
(12) Patent Application Publication
(10) Pub. No.: US 2010/0236130 A1
(43) Pub. Date: Sep. 23, 2010

(54) Simulated insect top water fishing lure

(76) Inventor: Paul T. Basso, Lynbrook, NY (US)

Correspondence Address: George J. Brandt, JR., 40 Ontario Road, Floral Park, NY, 11563, US

(21) Appl. No.: 12/383,308

(22) Filed: Mar. 23, 2009

(51) Int. Cl. A01K 85/01; A01K 85/00

(52) U.S. Cl. 43/42.31; 43/26.2; 43/17.1

(57) ABSTRACT

A top water fishing lure fashioned in the configuration of an insect is provided with vibration generation means embodied as a cartridge removably inserted in a watertight structure defining the lure body, operation of the vibration generation means the lure body producing vibrations which are replicated in the lure body, the body vibrations in turn transmitting to insect wing structure affixed to the lure body, the wing structure being caused to flex in manner as occurs when a live insect landed on the top water struggles to fly off th water surface, the components of the generation means being arranged in a piggyback array thereby enabling reduction in lure body size so as to better approach a size more like that of a live insect.

### FIELD OF THE INVENTION

The invention relates to fishing lures, particularly to lures that are termed top water lures and such lures as have a semblance of a winged insect.

### BACKGROUND OF THE INVENTION

Various forms of fishing lures are known. Generally these lures operate to create within a fish-containing environment, a sound, a lure movement, visual phenomena or other in water attraction calculated to draw and hook a fish. It is also known that winged insects, e.g., bees, wasps, moths, chicadas (June bugs) to name some, land on the surface of lakes, ponds and streams, this happening being produced by causes including wind, rain, accident, insect illness etc. A landed insect tries to escape from the water surface attempting to fly therefrom. This latter effort rarely is effective to allow insect escape. A result of insect wing fluttering is to produce disturbance on the water such as a certain low level noise but more importantly, the wings strike the water body surface creating ripples in the water, these ripples extending outwardly radially from the insect landed location. Fish react to the noise and water ripples by seeking the origin of the attraction moving instinctively toward the lure in quest of food but thereby entering a zone of jeopardy to the fish.

A problem associated with lures which are made to generate noise and lure body movements especially wing movements, is employment of devices such as eccentric mechanisms and drive motors driving the eccentric. These devices are relatively large and occupy space in a lure body that works against providing lure bodies approaching actual live insect body sizes. As a result, most known top water lures appear false or even grotesque in comparison to what known live insects actually look like.

Another problem associated with top water lures deals with effecting lure wing movements and the mechanisms employed for such purpose. These mechanisms have mechanical connection to the lure wings and require piercing the lure body with driving members. Although seals are provided where there is pass through of the body structure, leakage of water into the lure body often occurs, eventual submergence of the lure being the outcome.

It is desirable therefore, that a top water lure wherein wing flexing can be effected with driving means located wholly within the lure body be provided. Further, the driving means should be such as to allow reducing lure body size to one more consonant with live insect body sizes so that insect appearance simulation is realistic.

### OBJECTS AND SUMMARY OF THE INVENTION

An object of the invention is to provide a top water fishing lure simulative of a live insect such as a bee, wasp, moth, June bug, moth and the like wherein insect wing flexing is obtained without recourse to any lure body interior drive having to pass exterior of the lure body.

Another object of the invention is to provide a top water fishing lure which enables effecting flexing of insect wings of the lure without requiring use of any movable drive member engaging with or coming into contact with the wings.

Another object is to provide a top water fishing lure which simulates insect wing movements effected with means that does not to employ wing actuating components passing through the lure body housing thereby avoiding possibility of water entry into the lure body structure.

Another object is to provide a top water fishing lure in which the means embodied in the lure body for effecting wing movements are of more compact and smaller size components than heretofore used thereby enabling reduction in the size of the simulated insect body.

Another object is to provide a top water fishing lure in which components used for generating vibrations and operating same are arrayed in the lure body in a piggyback array rather than a component longitudinal aligned array so that reduction in longitudinal length of the lure body can be is achieved to bring same more closely to the comparable length of a live insect.

A further object is to provide the components for generating and controlling vibrations as same are embodied as a cartridge readily slidably insertable into a lure body during the making of the lure.

Another object is to provide a method for simply and surely assembling together the components and structure members of which the fishing lure is made.

In accordance with the invention, the fishing lure includes an elongate lure body in the form of a buoyant housing made up of front and rear housing portions which are removably assembled together in watertight joinder, the housing portions being configured in external shape to simulate the body of an insect. Hooks hang from each of the two opposite lure body ends. The lure body is colored in correspondence to the appearance of any of the given ones of insect forms in which it is contemplated the lure can be made. Also, the lure body will have external features such as simulate insect eyes etc. An insect wing structure is affixed to the top exterior surface of the lure body, the wing structure including distinct right and left portions which extend laterally outward of each of the two opposite sides on the lure body. The wing structure is a thin flexible member of suitable material allowing for flexing of the wing structure upwardly and downwardly relative of its point of fixing to the lure body. Wing structure can be made of any of a number of materials, polyvinylchloride being exemplary.

Disposed within the lure body are the components which generate vibrations within the lure body and which are replicated in the structure of the lure body since the components have transmissive contact with the lure body structure. These replicated vibrations are transmitted from the lure body to the wing structure causing it, due to its flexible construction, to flex up and down and make contact at its edge periphery with the surface of the body of water in which the lure is floating thereby creating fish attracting ripples in the surface of the water.

The components for generating vibrations include a controller for controlling vibration generation, a power source such as a battery, and a vibrator. The vibrator can be a coin type micro motor or it may be a cylindrical micro motor. The components are arranged in a piggy-backed relation one with others. As a result the longitudinal expanse of the components array is less than the sum of the longitudinal expanses of the individual components. This in turn shortens the required lure body length needed to house the components enabling closer to insect size than heretofore practiced.

The array of components can be fashioned as a package or cartridge which can be slidably received in a compartment formed within the lure body. The array can be formed of the coin type micro motor being affixed to an underside of a circuit board of the controller with the battery being carried in a holder comprising a pair of contact plates between which the battery is held. The holder is mounted at an upper side of the circuit board at an end region of the circuit board. The controller is disposed intermediate the coin type micro motor and the battery. Alternatively and in the instance where the vibrator is a cylindrical micro motor, the micro motor can be affixed at an upper side of the controller, the controller thereby being the lowermost disposed component in the array.

The tolerance of space between the component unitary structure and the lure body interior surfaces defining the housing space is one of closely adjacent relationship such that the lure body interior surface structure is in vibration transmissive engagement relationship with the array components. In other words, a vibration generated with the vibrator immediately transmits to the lure body and the vibrations in the lure body in turn transmit to the wing structure effecting flexing movement thereto.

Since a landed insect on the water surface seeks to fly off the surface, it will flex its wings. The insect will do this is cycle pattern of wing flexing, stopping the flexing, renewing flexing, stopping, etc. The controller can be programmed to effect any desired pattern of cyclic off/on conditions. For example, a 10 second on-10 second off vibration cycle could be used.

The invention also provides a method for assembling the fishing lure, the method involving assembling the vibration generating components in cartridge array as described above, fitting two conductor leads to the microprocessor circuitry with these leads extending a length that will locate the leads tip ends a distance from a frontmost end of the cartridge when the cartridge is mounted. Two openings are formed in the front tip end of front housing portion. The cartridge is then inserted into the front housing with the conductor leads free ends making first entry, the leads being registered with the housing openings and passed through the openings and exteriorly of the front housing front tip end. When the cartridge is fully seated in the front housing portion, the exterior of the housing lengths of the two leads are severed from the following lead lengths located within the front housing. A sealant can be introduced to the passages through which the leads must pass so that after the excess leads are severed, the sealant will set and make the front housing front end watertight to prevent water entry to the lure body. The severed leads tip ends function as switch contacts that are closed by the water action of the waterin which the lure is immersed. This switching actuation serves to activate controller circuitry.

The above and other objects, features and advantages of the invention will become apparent from the following description read in conjunction with the accompanying drawings, in which like reference numerals designate the same elements.

### TABLE OF DRAWINGS

FIG. 1 is a left front side perspective view of the fishing lure made in accordance with the invention.

FIG. 2 an exploded perspective view of the FIG. 1 lure.

FIG. 3 is a top plan view of the lure.

FIG. 4 is a right side elevational view of the lure.

FIG. 5 is a front end elevational view of the lure.

FIG. 6 is a sectional view taken on the line 6-6 in FIG. 4.

FIG. 7 is an elevational view on enlarged scale looking in the direction of arrow A in FIG. 5, the rear housing portion having been removed from the front housing portion to illustrate the piggyback positioning of the coin type vibration micro motor, battery, controller and associated circuitry within the front housing member.

FIG. 8 is a simplified wiring diagram of a circuit for controlling the operation of the lure.

FIG. 9 is a wiring diagram of an embodiment wherein the controller is a microprocessor.

FIG. 10 is a top plan view of the lure depicting a pattern of ripples created in the surface of the water when the wing structure is flexing responsive to vibrations generated by the coin type vibration micro motor.

FIG. 11 is an exploded perspective view of a front end fragmentary portion of an another lure embodiment where in the vibration means employs a cylindrical micro motor as well as its disposition within the front portion of the lure body.

FIG. 12 is a longitudinal sectional view similar to FIG. 6 but in respect of FIG. 11 lure embodiment.

FIG. 13 Is an elevational view on enlarged scale similar to FIG. 7 looking forward from the rear of the front end portion of the housing and as relates to FIG. 11 lure embodiment.

FIG. 14 is a perspective view of a vibration generation cartridge wherein the vibrator is a coin type micro motor.

FIG. 15 is a perspective view of a vibration generation cartridge wherein the vibrator is a cylindrical micro motor.

### DESCRIPTION OF THE PREFERRED EMBODIMENTS

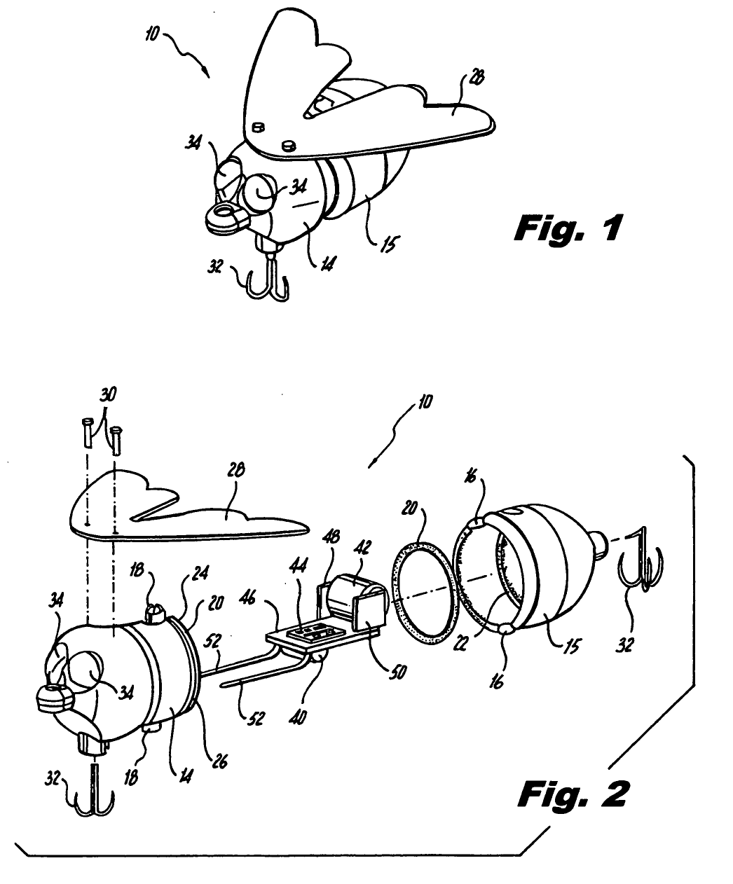

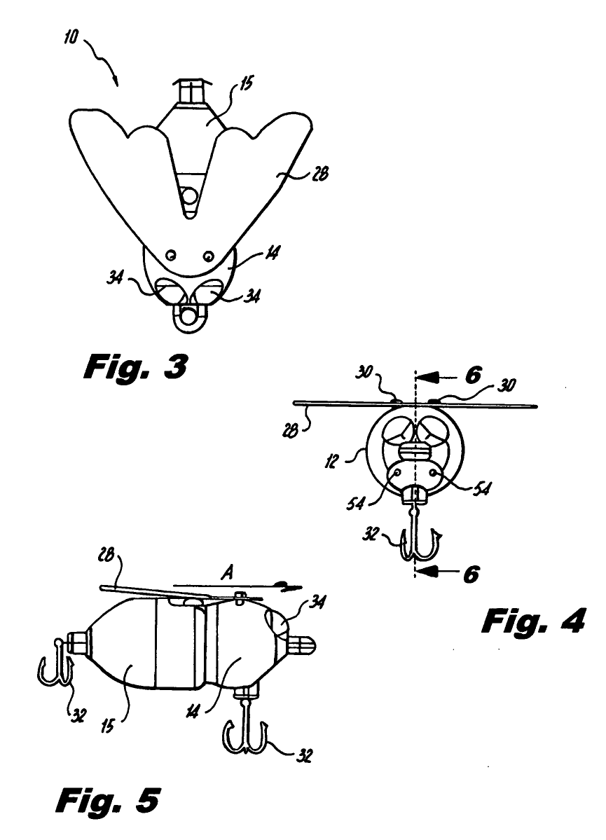

Referring to FIGS. 1 and 2, the fishing lure 10 comprises a watertight, buoyant lure body or housing 12 made up of a front housing portion 14 and a rear housing portion 15, these housing portions being connectable together by means of bayonet joint structure. Thus, one housing portion has diametrically opposed grooves 16 formed in an end segment of the portion, whereas, The other housing portion has diametrically opposed bosses 18 formed in an end segment of said other portion, the grooves and bosses cooperating to join the two housing portions in a watertight condition of joinder.

O-Ring seals 20 are provided in both housing portions 14, 15 to insure that the bayonet joint connection is leak proof. Thus, rear housing portion 15 is provided such as to receive an O-Ring 20 against an annular abutment 22 disposed inside rear housing portion 15, and be urged thereagainst by an annular ring end face 24 carried at an end of front housing part 14 when the bayonet jointing of the housing parts has been effected. Another O-Ring 20 is seated on an annular groove 26 formed at the periphery of the end segment of the front housing portion 14. FIG. 6 depicts the joined together housing portions 14, 15 and shows the in-line positioning of the two O-Rings 20 to effectively establish a barrier to entry of water through the bayonet joint.

Mounted to a forepart top of the exterior surface of front housing part 14 is wing structure 28 made of a flexible material such as a polyvinylchloride. The mounting of the wing structure to the front housing part 14 is with headed mounting pins 30. The housing portions 14, 15 can be made of various material, such as an ABS material, a polyethylene material and a polypropylene material these being some of the materials suitable for this purpose.

The housing 12 is configured in its external shape to have the semblance of a wasp. Also, distinguishing features of a selected insect type, can be provided to the housing, e.g., insect eyes 34. Additionally, the color of the selected insect also can be applied to the housing. Fish hooks 32 can be suspended from the housing at selected locations thereon.

The fishing lure 10 is a top water lure which floats on the surface of a body of water such as a brook, stream, lake or like fish inhabited water body. It functions to lure a fish with the attraction of a certain level of noise in the water, and with the attraction of flexing wings of an insect and the further attraction of water ripples created by flexing wing contacting with the surface of the water. To produce the attractions aforesaid, vibrations will be generated in the lure and for such purpose, explanation is given next below.

For the generation of vibrations therein, the lure 10 embodies a coin vibrator micro motor 40, such type of component being described in, for example, U.S. Pat. No. 6,600,245. Coin vibrator micro motors are available, for example, from Shanghai Junyang International Trading Co. Ltd. This company also supplies cylindrical micro motors of the type to be described later herein. A battery unit 42 is employed to power the micro motor and a controller 44 is used to control on/off operation of the micro motor, the controller having a circuit board 46 which carries printed circuitry associated with the functioning of the controller. The micro motor 40 is significantly smaller in size than, e.g., the drive motor vibration/rotary eccentric types heretofore used in fishing lures. The reduction in size of the vibration producing means enables a correspondent reduction in lure body size, so that a lure with body size better approaching the body sizes of live insects adds to the realistic appearance of the lure. The advent of coin micro size vibration motors has a parallel in that cylindrical micro motor size units are now available and employed in the present invention as will be described later below.

The components can be assembled together as a miniaturized structure array which occupies a minimized amount of space within the lure body, this being more fully understood with reference to FIGS. 2, 6 and 7 and being the result of piggyback mounting the components so that at least one such component is disposed in the array below others of components in the array. The array mounting provides that the longitudinal expanse of the array is measurably less that sum of the longitudinal expanses of the individual components.

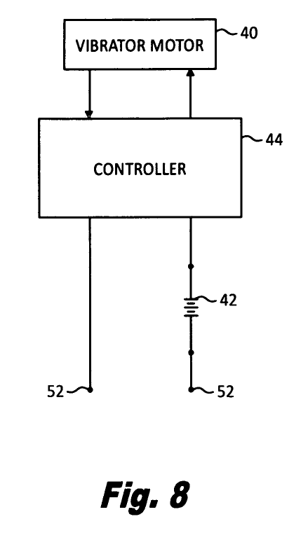

The structure array arrangement involves affixing the micro motor 40 to the underface of the circuit board 46 of the controller 44. Further, a pair of spaced apart conductive contact plates 48, 50 defining a battery holder are mounted fixedly to the circuit board at its upper face surface in an end region thereof, these contacts serving to engage in conductive contact, respectively, with the with positive and negative terminals of battery unit 42. A pair of conductive leads 52 in circuit with the controller 44 extend forwardly from the circuit board to pass through openings in the front end structure of the lure body, the leads extending outward a distance from the lure body as seen in FIG. 6. After assembly of the lure, the leads 52 are cut flush with the front end surface of the lure body, the tip ends 54 of the conductive leads 52 serving as the terminals of a water circuit closure switch for initiation of operation of the controller. The flush tip ends 54 are best seen in FIG. 4 and are depicted in FIG. 8 as well. Where the leads pass through the front end of the front housing, a sealant is pre applied to the passages so that the passages and exterior of the passage confined runs of the leads set to make the housing front end watertight.

Reception and affixing of the unitary structure in the lure body 12 is best understood with reference to FIGS. 6 and 7. The inner surface of the front housing portion 14 is provided with guidance structure in the form of a pair of spaced apart guide rails 58, 58′, each rail extending a short distance transversely of the housing portion inner surface toward the other rail. The rails and the arcuate housing portion encircling wall part 60 define the transverse envelope geometry of a compartment 62 for slidable receptive mounting of the unitary structure in the lure body, the compartment length extending to the inner side of the lure body front end. When so received, the lateral marginal parts of the circuit board 46 locate juxtaposed with undersides of the two rails. The contact plates 48, 50 are slightly inwardly of the side edges of the rails 58, 58′. The battery unit 42 is removably inserted between the inner faces of the contact plates 48, 50 with the respective battery terminals in conductive contact with the said inner faces. The circuit board side edges 88, as well as the bottom edges 89 of pins 90 with which the contact plates 48, 50, are connected to the circuit board are in closely adjacent proximity with encircling inner surface structure 60 of the housing portion 14 so that effective securement of the cartridge package and transmissive contact with the lure body is assured. Thus, vibrations generated with the package components readily transmit to the lure body. FIG. 6 shows how foreshortened the lure body length is made by nesting the unitary structure components in piggyback array.

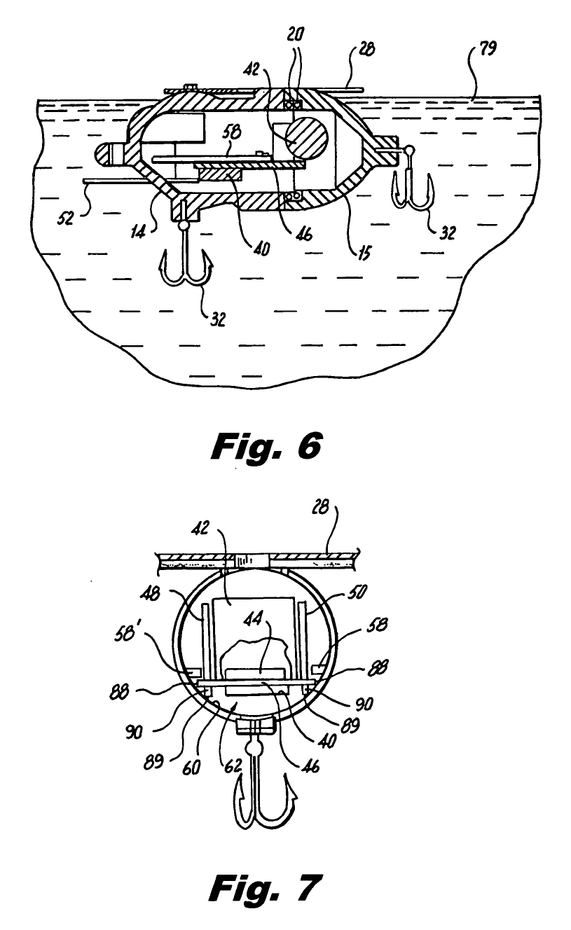

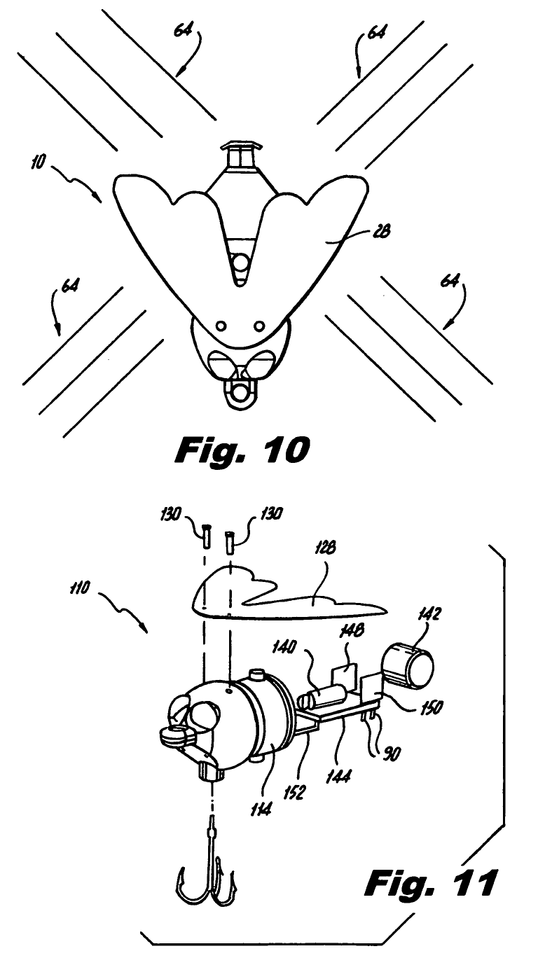

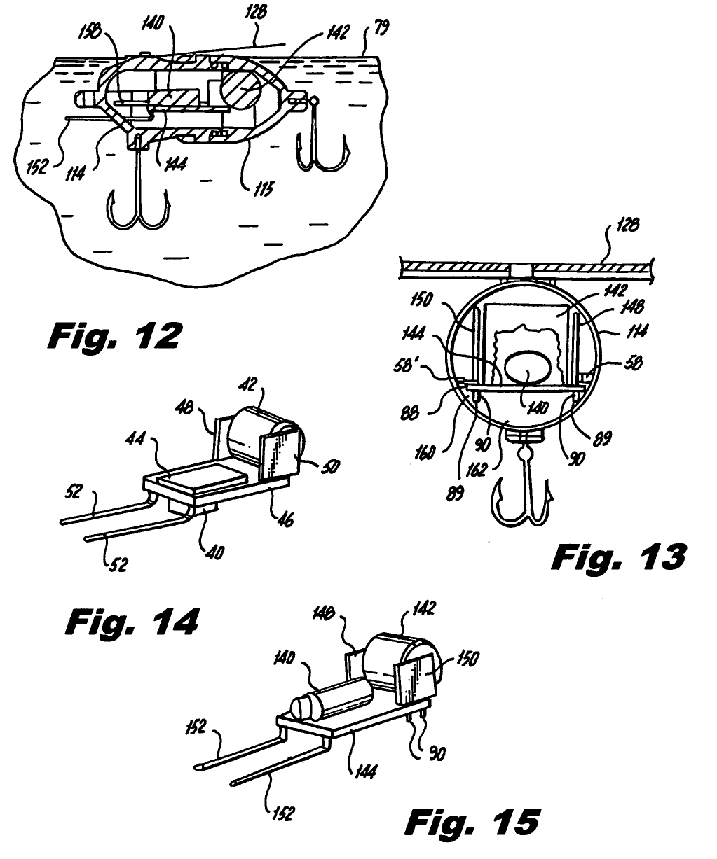

When the lure 10 is dropped on the water, the tip ends 54 of leads 52 have conductive continuity therebetween established by their immersion in the water body. This action sets up the controller to control operation of the lure to generate vibrations. The generated vibrations are replicated in the lure body and, in turn, in the wing structure 28. The vibrations can be generated in any of a number of selected a programmed sequences that simulates the wing flexure pattern a live insect makes in seeking to escape from landed state on the water surface. The insect wing flexing movements very rapid and the wing moving amplitude is not large. In a rest condition, i.e., when there is no vibration presence, the underside of the wing is located proximal above the surface of the water body 79 as seen, e.g., in FIGS. 6 and 7. During vibration generation, the wing tip periphery engages the water surface creating ripple movement in the water surface. FIG. 10 depicts the ripple effect which is like a pattern of striations 64 the wing movement occurs so fast that is difficult for a human to see. They often can only be seen with a strobe light shining on the wing structure. Regarding the wing structure, it is embodied with the lure body to extend rearwardly in a straight course as seen in FIG. 6, or it can me made to slope upwardly rearwardly, e.g., as seen in FIGS. 5 and 12.

Referring now to FIGS. 11-13, a second embodiment of the lure 110 is now described, the difference of this embodiment with lure 10 being employment of a cylindrical micro motor 140 as the vibrator in place of the coin type micro motor used in lure 10. Lure 110 also includes a pair of spaced conductor plates 148, 150 affixed to an upper surface of controller 144 for removably mounting the battery unit 142 on the upper surface of the controller. The micro motor 140 is also affixed to the upper surface of the controller 140. FIG. 12 and FIG. 13 depict the arrangement of the aforementioned components in a piggyback relationship as it is embodied as a cartridge is the same as that described earlier with respect to lure 10. The last two mentioned FIGS. particularly show how the utilization of the cartridge piggyback arrayed components enable having minimized longitudinal and transverse dimensioning of the lure body allowing more realistic live insect appearance of the lure.

FIGS. 14 and 15, depict the cartridge constructions employed if lure 10 and 110, respectively.

FIG. 8 is a simplified showing of the circuit operation of the lure 10. Terminals 52, 52 are bridged by the water in which the lure 10 is floating closing the circuit so that battery 42 supplies power via the controller 44 to the vibrators 40 and 140.

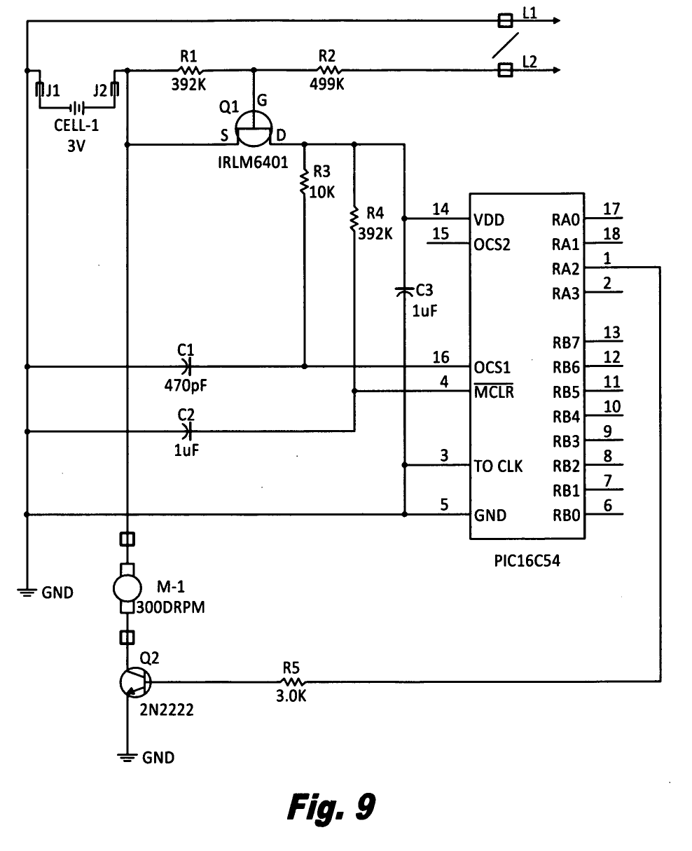

FIG. 9 is a wiring diagram of the lure circuitry wherein a microprocessor is used as the controller. One having ordinary skill in the art will understand that the FIG. 9 microprocessor operates the vibrator in accordance with pre-programmed data in the microprocessor including on and off periods of operation as well as the duration of the periods all subject to being changed by changing the pre-programming data input to the microprocessor. An example of an on-off periods programmed in the microprocessor is given in the next below table.

TABLE A

| Step | |
|---|---|
| 0 | Motor on |
| 1 | 4 sec on |
| 2 | Motor off |
| 3 | 8 sec off |
| 4 | Motor on |
| 5 | 1 sec on |
| 6 | Motor off |
| 7 | ⅓ sec off |
| 8 | Motor on |
| 9 | 1 sec on |
| 10 | Motor off |
| 11 | ⅓ sec off |
| 12 | Motor on |
| 13 | 1 sec on |
| 14 | Motor off |
| 15 | 10 sec off |
| 16 | Motor on |
| 17 | 1 sec on |
| 18 | Motor off |
| 19 | ⅓ sec off |
| 20 | Motor on |
| 21 | 1 sec on |
| 22 | Motor off |
| 23 | ⅓ sec off |
| 24 | Motor on |
| 25 | 1 sec on |
| 26 | Motor off |
| 27 | 10 sec off |
| Jump back | |
| to Step 0 | |

Having described preferred embodiments of the invention with reference to the accompanying drawings, it is to be understood that the invention is not limited to these precise embodiments, and that various changes and modifications may be effected therein by one skilled in the art without departing from the scope or spirit of the invention as defined in the appended claims.

1. A top water fishing lure comprising:
an elongated housing defining a lure body structure, said housing being buoyant sufficient to float on a surface of a water body:
a vibration generator carried in said housing, said vibration generator including as components,
an electric power source,
a electric powered micro motor vibrator, and
a controller for controlling operation of said vibrator, said components being arrayed in a piggyback relation one component with others of said components such that a longitudinal expanse dimension of said components array is less than a sum of the longitudinal expanse dimensions of each of said components thereby enabling lessening of a housing longitudinal length required to enclose opposite array ends in close proximal adjacency with opposite housing ends; and
wing structure including portions extending laterally outward of each of opposite sides of said housing, said vibration generator having transmissive engagement with housing structure such that generated vibrations are replicated in said housing, lower faces of said laterally extending wing portions normally disposing spaced proximal adjacent above said water body surface in absence of vibrations in said housing but flexing into and out of contact with said water body surface responsive to vibration presence in said housing thereby creating fish attracting ripple arrays in said water body surface.

2. A fishing lure in accordance with claim 1, in which said electric power source is an electric storage battery unit, said controller mounting spaced conductive plates at an upper face of said controller for reception of said battery unit therebetween with terminals of said battery unit conductively engagable with said conductive contact plates.

3. A fishing lure in accordance with claim 2, in which said micro motor vibrator is a coin type micro motor.

4. A fishing lure in accordance with claim 2, in which said micro motor vibrator is disposed in the piggyback relation array one of at an underface and an upper face side of said controller.

5. A fishing lure in accordance with claim 2, in which said micro motor vibrator is a cylindrical type micro motor.

6. (canceled)

7. A fishing lure in accordance with claim 1, in which said housing comprises front and rear housing portions, one housing portion having a joining segment removably connectable with a joining segment of a other housing part to effect watertight joinder together of said housing parts.

8. A fishing lure in accordance with claim 7, in which said joining segments are those of a bayonet joint structure.

9. A fishing lure in accordance with claim 7, in which the watertight joining is effected with O-ring members carried in each of the housing portions segments.

10. A fishing lure in accordance with claim 1, in which an external surface of said housing is configured in semblance of a living insect.

11. A fishing lure in accordance with claim 1, in which said housing is made of one of ABS material, a polyethylene, and a polypropylene material.

12. A fishing lure in accordance with claim 1, further comprising at least one fish hook affixed to said lure body.

13. A vibration generator mountable in a fishing lure housing, comprising as components:
an electric powered micro motor vibrator;
an electric power source; and
a controller for controlling operation of said vibrator, said components being arrayed in a piggyback relation one component with others of said components such that a longitudinal expanse of said components array is less than a sum of the longitudinal expanse dimensions of each of said components thereby enabling lessening of a housing longitudinal length required to enclose opposite array ends in close proximal adjacency with opposite housing ends.

14. A fishing lure in accordance with claim 18, in which said micro motor is a coin type micro motor affixed at said circuit board underside.

15. A fishing lure in accordance with claim 18, in which said micro motor is a cylindrical micro motor affixed at said circuit board upper surface.

16. (canceled)

17. A vibration generator in accordance with claim 13, wherein:
said vibration generator is embodied as a cartridge comprising structure slidably engageable with internal longitudinal guidance structure extending therein from a housing entry opening in a direction of a housing closed end.

18. A vibration generator in accordance with claim 17, wherein:
said controller includes a circuit board, there being a battery holder including a pair of spaced conductive contact plates a pair of spaced conductive contact plates affixed to an upper surface of said circuit board at an end region of said circuit board, said battery being removably receivable between said contact plates with terminals of said battery conductively engaging said contact plates, said vibrator being affixed to one of an underside of said circuit board and said upper surface of said circuit board, and
sliding travel mounting insertion of said cartridge into said housing is effected with longitudinal side marginal areas of said circuit board upper surface juxtaposed with said guidance structure.
